(19) United States
(12) Patent Application Publication
(10) Pub. No.: US 2024/0403281 A1
(43) Pub. Date: Dec. 5, 2024

(54) METHOD OF CREATING INDEX OF BLOCKCHAIN DATA AND DEVICE AND METHOD FOR SEARCHING FOR BLOCKCHAIN DATA

(71) Applicant: ELECTRONICS AND TELECOMMUNICATIONS RESEARCH INSTITUTE, Daejeon (KR)

(72) Inventors: Dong Myung Sul, Daejeon (KR); Ji Yong Kim, Daejeon (KR); Mi Young Jang, Daejeon (KR)

(21) Appl. No.: 18/633,715

(22) Filed: Apr. 12, 2024

(30) Foreign Application Priority Data
May 31, 2023 (KR) 10-2023-0069936
Feb. 23, 2024 (KR) 10-2024-0026204

(51) Int. Cl. G06F 16/22; H04L 9/00

(52) U.S. Cl. CPC G06F 16/2228; H04L 9/50

(57) ABSTRACT

Provided are a method of creating an index for blockchain data and a device and method for searching for blockchain data. The method of creating an index for blockchain data includes receiving, by a blockchain data search device, data to be stored in a blockchain network from a user application, requesting, by the blockchain data search device, the blockchain network to store the data and receiving a block number of a block in which the data is stored and a transaction identifier (ID) from the blockchain network when storage of the data is completed, and encrypting, by the blockchain data search device, the data and creating an index for the data on the basis of the encrypted data, the block number, and the transaction ID.

### CROSS-REFERENCE TO RELATED APPLICATIONS

This application claims priority under 35 U.S.C. § 119 to Korean Patent Applications No. 10-2023-0069936, filed on May 31, 2023, and No. 10-2024-0026204, filed on Feb. 23, 2024, in the Korean Intellectual Property Office, the disclosure of which is incorporated herein by reference in its entirety.

### BACKGROUND

### 1. Field of the Invention

The present invention relates to a device and method for generating an index on a blockchain platform, which is a distributed database, and searching for data using the generated index.

### 2. Description of Related Art

A blockchain platform is a type of distributed database, in which a large number of nodes store and verify data, thus showing lower search performance than general centralized databases. The reasons for low search performance of blockchains for transaction data are listed below.

A1. Complexity of search process: The process of searching transaction data in a blockchain is much more complex than a general database search. In particular, it is necessary to understand the creation process of a blockchain transaction, identify a data storage structure, and process and verify blockchain transaction data at a very high rate, which may cause performance degradation in the search process.

A2. Blockchain size: Unlike databases in which data storage and deletion are allowed, blockchain data is irreversible once stored and continuously increases over time, which leads to a reduction in search speed. In particular, when a transaction, which will be searched for, occurred a long time ago or large-capacity or big transactions occur frequently, it may be necessary to search many blocks to find the corresponding transaction.

A3. Network latency: As a distributed system, a blockchain requires a certain amount of time to transmit and receive information between nodes in the process of transaction settlement, data storage, and the like. For this reason, network latency may occur, which leads to a reduction in search speed.

A4. Verification process: Before a new block is added to a blockchain, it is necessary to verify the content of the block. This process involves a large amount of calculation, reducing search speed.

For the above reasons, the process of searching for transaction data in a blockchain is more complex and slower than a general database search.

To solve the above problems, a method of using a limited range of searches available on a blockchain platform (blockchain network) (also referred to as “B1”) and a method of copying blockchain data to an external database and then using a search service provided by a database system (also referred to as “B2”) have been proposed.

In the case of the search method using an application programming interface (API) provided by a blockchain platform (B1), only values (a block number and a transaction identifier (ID)) used by the blockchain can be asked for. To search data input by a user rather than these values, it is necessary to sequentially read and compare blocks managed by the blockchain network from the first block, which degrades search efficiency.

Meanwhile, the method of copying blockchain data to an external database and using a data search service (B2) has some problems. External databases may use a centralized data storage. This is counter to distribution, one of the core values of blockchains. Also, the centralized data storage has potential risks of data alteration and manipulation. External databases do not ensure high safety of blockchains. A blockchain is a decentralized network and employs encryption technology and consensus technology to ensure the integrity and security of data. However, external databases do not use such a safety-ensuring method, which may lead to security problems such as data forgery.

In addition to the methods B1 and B2, a method of indexing blockchain data and searching for data using an index (also referred to as “B3”) has been proposed to solve the performance problems.

The blockchain data indexing technology B3 is used for efficient search and enquiry in a blockchain. Since a blockchain is a huge distributed database, it is difficult to rapidly search through all transactions. To solve this problem, the blockchain data indexing technology B3 provides a method of indexing transaction information and facilitating a search.

The type of blockchain index may be defined according to the type of data stored in a blockchain. Also, hash which is the representative technology of blockchains may be used for replacing specific data with a hash value through a hash function, and the hash value may be stored and used for a search. In addition, a block number, an address, a time, a transaction ID, or the like may be used as a key to generate an index which supports a rapid search.

The blockchain data indexing technology (B3) plays a significant role in addressing the scalability problem of blockchains. Since a blockchain is a distributed database, search speed and performance are degraded with an increase in the amount of transaction data. Therefore, it is possible to increase search speed and performance by employing the blockchain data indexing technology (B3).

When blockchain data is copied to an index server and used for generating a blockchain data index, the original data is exposed externally. When data stored in a blockchain is exposed externally, possible problems are as follows.

C1. Problem with personal information protection: When data used in a transaction includes personal information, such as a name, an address, and the like, the sensitive data may be exposed externally.

C2. Problem of data forgery: Blockchains are characterized by irreversibility representing that data is not removable once recorded, and integrity representing that data is safely stored without being manipulated or changed. However, when original data is copied to an external index server to generate an index, an attack may occur such as a malicious service provider providing a search service after deleting or changing the original data at will and the like.

C3. Problem of unnecessary data exposure: When information which is unnecessary for providing a search service among information stored in a blockchain is exposed externally, there is a possibility of spam or malicious code being distributed by exploiting the information.

C4. Legal problems: When data stored in a blockchain is exposed externally, legal problems may occur. All the foregoing problems C1 to C4 lead to legal problems such as leakage of personal information, data misuse, and the like.

### SUMMARY

The present invention is directed to providing a device and method for generating a partial index and searching for data on the basis of an encryption key that may fundamentally prevent external exposure of blockchain data by encrypting the blockchain data when an index is generated in a blockchain platform environment.

Specifically, according to the device and method for generating a partial index and searching for data on the basis of an encryption key, a transaction value (a transaction identifier (ID), a block ID, or the like) including encrypted data, which is a key, is set as a value to generate an index, and in the case of a data search, actual transaction data is requested from the blockchain network using the transaction information of the encrypted data found with the index, and the original data is received.

The present invention is directed to providing a device and method for generating a partial index and searching for data on the basis of an encryption key, according to which partial indexes are generated for certain data units obtained by dividing data using an append-only characteristic based on the irreversibility of a blockchain system, a search result is received from each partial index using a characteristic that pieces of transaction data are independent of each other, and then original data is requested from multiple nodes of a blockchain network using the search results.

Objects of the present invention are not limited to those described above, and other objects which have not been described will be clearly understood by those of ordinary skill in the art from the following description.

According to an aspect of the present invention, there is provided a method of creating an index for blockchain data, the method including (a) receiving, by a blockchain data search device, original data to be stored in a blockchain network from a user application, (b) requesting, by the blockchain data search device, the blockchain network to store the original data and receiving a block number of a block in which the original data is stored and a transaction ID from the blockchain network when storage of the original data is completed, and (c) encrypting, by the blockchain data search device, the original data and creating an index for the original data including the encrypted original data, the block number, and the transaction ID.

Operation (c) may include applying, by the blockchain data search device, a different encryption method according to a type of original data to encrypt the original data.

Operation (c) may include, when the original data is a string, applying, by the blockchain data search device, an encryption algorithm for matching the original data with the encrypted data on a one-to-one basis to encrypt the original data.

Operation (c) may include, when the original data is numeric data, applying, by the blockchain data search device, an order-preserving encryption (OPE) algorithm to encrypt the original data.

Operation (c) may include, when an index stored in a memory exceeds a range specified by a division criterion, storing, by the blockchain data search device, index data corresponding to the range specified by the division criterion in a new file.

The division criterion may be set on the basis of any one or a combination of a time period, a block number, and a data size.

According to another aspect of the present invention, there is provided a method of searching for blockchain data using an index, the method including (a) receiving, by a blockchain data search device, a query about original data stored in a blockchain network from a user application and (b) encrypting, by the blockchain data search device, search condition data included in the query and searching for a pre-created index using the encrypted search condition data to extract a block number of a block in which the original data is stored and a transaction ID.

The method may further include (c) receiving, by the blockchain data search device, blockchain data from a plurality of nodes included in the blockchain network on the basis of the block number and the transaction ID and (d) combining, by the blockchain data search device, the received blockchain data to generate final blockchain data and transmitting the final blockchain data to the user application.

Operation (b) may include searching for a plurality of pre-created partial indexes using the encrypted search condition data to extract the block number of the block in which the original data is stored and the transaction ID.

According to another aspect of the present invention, there is provided a device for searching for blockchain data, the device including a memory configured to store computer-readable instructions and at least one processor configured to execute the instructions.

The at least one processor may execute the instructions to receive original data to be stored in a blockchain network from a user application, request the blockchain network to store the original data, receive a block number of a block in which the original data is stored and a transaction ID from the blockchain network when storage of the original data is completed, encrypt the original data, create an index for the original data including the encrypted original data, the block number, and the transaction ID, and store the index in the memory.

The at least one processor may encrypt the original data by applying a different encryption method according to a type of original data.

When the original data is a string, the at least one processor may apply an encryption algorithm for matching the original data with the encrypted data on a one-to-one basis to encrypt the original data.

When the original data is numeric data, the at least one processor may encrypt the original data by applying an OPE algorithm.

The device may further include a storage device. When an index stored in the memory exceeds a range specified by a division criterion, the at least one processor may store index data corresponding to the range specified by the division criterion on the basis in a new file through the storage device.

When a query about the original data stored in the blockchain network is received from the user application, the at least one processor may encrypt search condition data included in the query and search for a pre-created index using the encrypted search condition data to extract the block number of the block in which the original data is stored and the transaction ID.

The at least one processor may receive blockchain data from a plurality of nodes included in the blockchain network on the basis of the block number and the transaction ID, generate final blockchain data by combining the blockchain data, and transmit the final blockchain data to the user application.

The at least one processor may create a plurality of pre-created partial indexes including the encrypted search condition data, the block number, and the transaction ID and extract the block number of the block in which the original data is stored and the transaction ID by simultaneously searching for the plurality of partial indexes using the encrypted search condition data.

### BRIEF DESCRIPTION OF THE DRAWINGS

The above and other objects, features and advantages of the present invention will become more apparent to those of ordinary skill in the art by describing exemplary embodiments thereof in detail with reference to the accompanying drawings, in which:

FIG. 1 is a block diagram of a device for searching for blockchain data according to an exemplary embodiment of the present invention;

FIG. 2 is a block diagram illustrating the concept of a blockchain data search employing indexers;

FIG. 3 is a diagram illustrating an indexing process of the device for searching for blockchain data according to the exemplary embodiment of the present invention;

FIG. 4 is a diagram illustrating a data request process of the device for searching for blockchain data according to the exemplary embodiment of the present invention;

FIG. 5 is a diagram illustrating a blockchain data distribution request and blockchain data aggregation process of the device for searching for blockchain data according to the exemplary embodiment of the present invention;

FIGS. 6A and 6B are flowcharts illustrating a method of creating an index for blockchain data and a method of searching for blockchain data according to an exemplary embodiment of the present invention; and

FIG. 7 is a block diagram of a computer system for implementing the method of creating an index for blockchain data and the method of searching for blockchain data according to an exemplary embodiment of the present invention.

### DETAILED DESCRIPTION

The present invention relates to a device and method for generating an index on a blockchain platform, which is a distributed database, and searching for data using the index. To solve the foregoing problems of the related art, the present invention prevents data from leaking externally through an index by generating the index using an encrypted key and allows a rapid search by dividing data according to a certain criterion in consideration of characteristics of a blockchain system, indexing the divided data in a distributed manner, and processing the divided data in parallel in the case of a data search.

According to the present invention, in the case of generating an index in a blockchain platform environment, blockchain data is encrypted to fundamentally prevent external exposure of the blockchain data. According to a device and method of the present invention, transaction information (a transaction identifier (ID), a block ID, or the like) including encrypted data is stored as a value in an index using the encrypted data as a key. Also, according to the device and method, actual transaction data (original data) is requested from the blockchain network using the transaction information of the encrypted data found with the index and the original data is received. In this way, according to the device and method, unnecessary data can be prevented from leaking externally, and only wanted data can be rapidly searched for.

Also, the present invention proposes a method of generating partial indexes for certain data units obtained by dividing data using an append-only characteristic based on the irreversibility of a blockchain system and performing query and management using a partial index. In other words, according to the present invention, a search result is obtained using each partial index on the basis of a characteristic that pieces of transaction data are independent of each other, and then original data is requested from multiple nodes of a blockchain network in a distributed manner using the search results. Therefore, the present invention allows parallel processing in an index search, which reduces a search processing time.

As described above, according to the present invention, an index is created by encrypting blockchain data. To search for encrypted data stored in an index without a decoding process, an index server creates indexes by applying a different encryption algorithm according to a data type. Since indexes are created using encrypted data as keys, the present invention can fundamentally prevent leakage of original blockchain data.

Among current encryption algorithms, an encryption algorithm which may generate unique encrypted data matching original data (plain text) on a one-to-one basis and simultaneously perform a compare operation between encrypted data is of limited use for practical searches. Therefore, when a type of index data is a string, the present invention is assumed to provide an exact match search using the encryption algorithm in which original data (plain text) matches encrypted data on a one-to-one basis.

According to the present invention, when a type of index data is numeric data, an order-preserving encryption (OPE) algorithm which provides equality, comparison, and range searches is selected. The OPE algorithm supports search efficiency by generating encrypted data having the same order as the original data. When a ciphertext is generated with a block encryption algorithm according to the related art, the size and form of the ciphertext become different from those of plain text, and thus decryption is necessary for size comparison. Also, when data in a database in use is encrypted, it is not possible to use previously generated indexes, which incurs the cost of generating indexes. Accordingly, there is a necessity for an encryption algorithm for comparing the size of a ciphertext with the size of plain text or using indexes previously generated in a database even after encryption data is generated. The OPE algorithm has been proposed to satisfy these requirements. A representative OPE algorithm is Programmable Order-Preserving secure Index Scheme (POPIS). POPIS is an encryption algorithm based on a monotone increasing function and involves the following equation:

E(x)=a*x+b+noise

To preserve the order and prevent a ciphertext from being deduced, a random value extracted from the range from 0 to a is used as noise. For example, when a and b are respectively 2 and 7 and x is 1 and 2, E (1)=2*1+7+noise, and E(2)-2*2+7+noise. Since the value of E(1) ranges from 9 to 11 and the value of E(2) ranges from 11 to 13, E(2)>E(1). Due to this characteristic, in a database which is encrypted using the OPE algorithm, it is possible to use plain-text indexes without any change or perform matching or query without decoding. In the example, small values are assumed as the original text and noise, and thus it seems that an encryption function would be guessable to a certain degree with an increase in the number of ciphertexts. In practice, however, it is possible to make it harder to guess the encryption function by randomly generating and applying a, b, and noise having a certain value or more every time a query manager generates a new index.

When data used in an index is encrypted with the OPE algorithm and used, an index key is encrypted and stored, which can prevent an attack of deciphering an index in a database. Also, when an index key is encrypted with the OPE algorithm, it is possible to protect important data such as personal information. When a database is used in a cloud service and an index key is encrypted with the OPE algorithm, a third party, such as a cloud service provider, can be prevented from accessing encrypted data.

Using an encrypted index key has benefits in security and personal information protection, but there are disadvantages including performance degradation, complicated implementation, and the like. However, according to the present invention, only key values are encrypted. Accordingly, performance degradation is insignificant, and the advantages of security and personal information protection are great.

Advantages and features of the present invention and methods of achieving them will become clear with reference to exemplary embodiments described below in detail in conjunction with the accompanying drawings. However, the present invention is not limited to the embodiments disclosed below and may be implemented in various different forms. The embodiments are provided only to make the disclosure of the present invention complete and fully convey the scope of the present invention to those skilled in the technical field to which the present invention pertains, and the present invention is only defined by the scope of the claims. Terminology used herein is for describing the embodiments and is not intended to limit the present invention. In this specification, singular forms also include plural forms unless specifically stated otherwise. As used herein, “comprise” and/or “comprising” specify the presence of constituent elements, steps, operations, and/or devices but do not preclude the presence or addition of one or more other constituent elements, steps, operations, and/or devices.

Unless otherwise specified, singular expressions should generally be construed as “one or more.” In this specification, the terms “include,” “have,” and the like specify the presence of described features, integers, steps, operations, components, parts, or combinations thereof but do not preclude the presence or addition of one or more other features, integers, steps, operations, components, parts, or combinations thereof.

The terms “first,” “second,” and the like may be used for describing various components, but the components are not limited by the terms. The terms may be used for the purpose of distinguishing one component from others. For example, a first component may be named a second component without departing from the scope of the present invention, and similarly, a second component may be named a first component.

When a first component is referred to as “connected” or “coupled” to a second component, the first component may be directly connected or coupled to the second component, or a third component may be interposed therebetween. On the other hand, when a first component is referred to as “directly connected” or “directly coupled” to a second component, there is no third component therebetween. Other expressions describing the relationship between components, such as “between” and “just between,” “adjacent to” and “directly adjacent to,” and the like, should be interpreted in the same manner.

In describing the present invention, when it is determined that detailed description of related well-known technology will unnecessarily obscure the gist of the present invention, the detailed description will be omitted.

Hereinafter, exemplary embodiments of the present invention will be described in detail with reference to the accompanying drawings. In describing the present invention, to facilitate overall understanding, the same reference numeral will be used for the same element throughout the drawings.

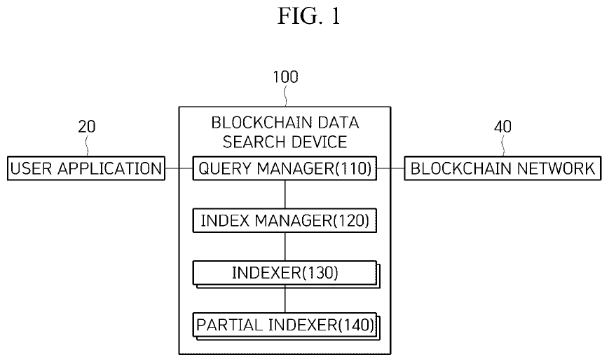

FIG. 1 is a block diagram of a device for searching for blockchain data according to an exemplary embodiment of the present invention.

A device 100 for searching for blockchain data according to the exemplary embodiment of the present invention includes a query manager 110, an index manager 120, and an indexer 130 and may further include a partial indexer 140.

There may be a plurality of indexers 130 and partial indexers 140. When there are a plurality of indexers 130, the indexers are referred to with different reference numerals, such as 130-1, 130-2, and the like, and when there are a plurality of partial indexers 140, the partial indexers are referred to with different reference numerals such as 140-1, 140-2, and the like.

The device 100 for searching for blockchain data may be implemented in the form of a computer system. All the components of the device 100 for searching for blockchain data may be implemented in one server. For example, each of the query manager 110, the index manager 120, the indexers 130, and the partial indexers 140 may be implemented as a software module in one server.

Also, the components of the device 100 for searching for blockchain data may be implemented in separate servers. For example, the plurality of indexers 130-1, 130-2, and the like and the plurality of partial indexers 140-1, 140-2, and the like may be implemented in different servers. In this case, each indexer 130 may be referred to as an “index server,” and each partial indexer 140 may be referred to as a “partial index server.”

The device 100 for searching for blockchain data shown in FIG. 1 is in accordance with the exemplary embodiment. Components of the device 100 for searching for blockchain data are not limited to those shown in FIG. 1 and may be added, changed, or removed as necessary.

The device 100 for searching for blockchain data is connected to a user application 20 and a blockchain network 40. The blockchain network 40 includes multiple nodes 41.

The query manager 110 receives a data storage request or data query (also referred to as a “query about blockchain data” or “data search request”) from the user application 20 and processes the data storage request or data query.

When the query about blockchain data is received from the user application 20, the query manager 110 requests necessary information from the blockchain network 40 and the index manager 120 and processes the query. When initially configured, the index manager 120 generates and manages the indexers 130 on the request from the query manager 110 and processes data indexing and a search request. The index manager 120 separately generates and manages the indexers 130 according to data types.

An overall process in which the device 100 for searching for blockchain data indexes blockchain data or searches for blockchain data in the blockchain network 40 using the query manager 110 and the index manager 120 according to an exemplary embodiment of the present invention will be described below.

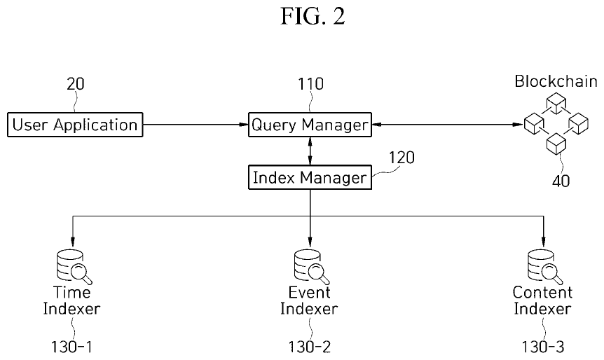

FIG. 2 is a block diagram illustrating the concept of a blockchain data search employing indexers.

When a transaction occurs in the user application 20, a process of storing data of the transaction in the blockchain network 40 and an index is as follows. The user application 20 requests the query manager 110 to store generated original data. The query manager 110 converts the original data into a transaction structure, forwards the converted original data to the blockchain network 40, and stores the converted original data in the blockchain network 40. The blockchain network 40 returns a block number and transaction ID which are generated by storing the original data converted into the transaction structure, to the query manager 110 as result values. The query manager 110 shares the types of generated indexes and index-specific storage data structure information with the index manager 120 and thus may classify information to be stored in an index by analyzing the block number and transaction ID received from the blockchain network 40. In other words, the query manager 110 extracts the block number in which the original data is stored, the transaction ID, and an index key (data) from the blockchain network 40, encrypts the block number, the transaction ID, and the index key, and then forwards the corresponding information to the index manager 120 along with an index ID of an indexer 130 in which the corresponding information will be stored so that the index manager 120 stores the corresponding information in the indexer 130.

In the present invention, the query manager 110 uses a different encryption method depending on the type of original data to be indexed. When the original data is numeric data, the query manager 110 selects the OPE algorithm for exact-match, comparison, and range searches. In general query processing, a range-match search for numeric data is an important function that is necessary. For example, in the case of searching for time, location information, various numeric measures, or numerically expressible values, it is necessary to not only perform an exact-match search for searching for a specific value but also search for data within a specific range.

When the original data is a string rather than a number, the query manager 110 selects an encryption algorithm such as secure hash algorithm (SHA)-3 for matching the original data with encrypted data on a one-to-one basis. The encryption algorithm provides exact match searches.

In this case, an indexer 130 may retrieve a result value by searching for an encrypted key value itself without decryption for key matching and thus can minimize performance limitations.

In the exemplary embodiment of FIG. 2, the indexers 130 are distinguished by keys indexed by the indexers 130. The time indexer 130-1 performs indexing by time, the event indexer 130-2 performs indexing for keys that satisfy certain conditions, and the content indexer 130-3 performs indexing for partially matching value content. The content indexer 130-3 is suitable for indexing some content having a large value. For example, when an address is included in a value, the content indexer 130-3 generates an index for partial matching, such as a city, a state, and a zip code, rather than the entire address. A key value and an index are generated on a one-to-one basis. When a key is content, the content indexer 130-3 generates three indexes as an index for “city,” “state,” and “zip code.”

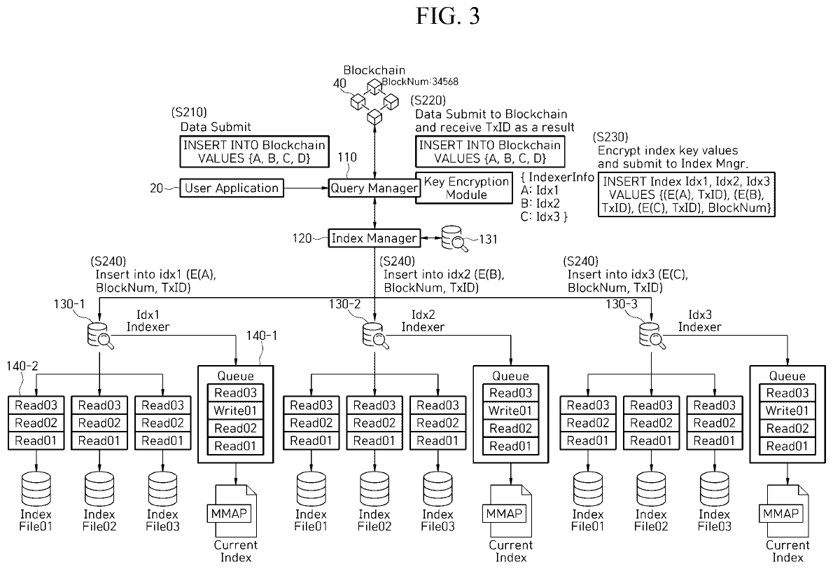

FIG. 3 is a diagram illustrating an indexing process of the device for searching for blockchain data according to the exemplary embodiment of the present invention. FIG. 3 shows an intermediate process for indexing when the user application 20 stores original data in the blockchain network 40.

When a data storage request is received from the query manager 110, the index manager 120 forwards a block number, a transaction ID, and encrypted data to the individual indexers 130-1, 130-2, 130-3, etc. and requests data indexing. The individual indexers 130-1, 130-2, 130-3, etc. store index data in which encrypted data is set as a key and a block number and a transaction ID are set as values. Since the data stored in the individual indexers 130-1, 130-2, 130-3, etc. is encrypted (encrypted original data), it is not possible to know the meaning of received values. Also, since a searchable encryption technique is used, no computation for decryption is necessary in an index creation operation. Accordingly, it is not possible to find the actual meaning of the corresponding data, and thus the device 100 for searching for blockchain data according to the exemplary embodiment of the present invention can fundamentally prevent external exposure of data.

Due to the characteristics of blockchain systems, blockchain data is only allowed to be stored and then is not allowed to be modified or deleted. Accordingly, the sizes of indexers 130 and 131 continuously increase. For this reason, the performance of an indexer-based search is continuously degraded over time.

To solve this problem, the index manager 120 of the device 100 for searching for blockchain data according to the exemplary embodiment of the present invention sets a division criterion (e.g., a time period, a block number, and a data size) for each of individual indexers 130-1, 130-2, 130-3, etc. When index data (an index) stored in a memory exceeds a range specified by the division criterion due to newly added data, the indexer 130 stores and manages index data that has been stored in the memory up to the present time as a new file (file index). The indexers 130 manage the recently generated index data as a memory-based index.

For example, when the index data stored in the memory exceeds a time period range, a block number range, or a maximum data size specified by the division criterion, the indexer 130 generates a new file index and stores and manages index data corresponding to the specified range based on division in a new file index.

For example, when block numbers are a division criterion, a final block number and a block number range assigned to each file index may be managed as follows:

```
{ IndexInfo
  LastBlockNum:34567
  File01: Block 1~9999
  File02: Block 10000~19999
  File03: Block 20000~29999 }
```

The device 100 for searching for blockchain data according to the present invention generates multiple file indexes according to the foregoing division criterion and separately stores the multiple file indexes. Accordingly, in the case of processing a query about blockchain data (a data search request) thereafter, the device 100 for searching for blockchain data searches the separately stored file indexes rather than one index of all blockchain data. This allows parallel processing of the query, increasing a data search speed. Also, when a range of the search request does not exceed a division criterion (a time period or a block number), the device 100 for searching for blockchain data according to the present invention is not required to search for another file index, which reduces unnecessary searches. Also, in the case of latest data with a high search frequency or high-frequency search data, the device 100 for searching for blockchain data generally copies an index file including the data and stores the index file at various points, which allows rapid processing of multiple queries through parallel processing.

Even in the case of adding an index for blockchain data that has not been indexed, the device 100 for searching for blockchain data does not store all the blockchain data in one index and can divide the blockchain data according to a division criterion, distribute the divided blockchain data to several points, and generate indexes in parallel, which allows rapid processing.

Each of the indexers 130 manages a plurality of partial indexers 140. The partial indexers 140 may be included in or connected to the indexer 130 and process an index generation request or an index search request from the indexer 130. For example, the indexer 130-1 may transmit an index generation request or an index search request to the partial indexers 140-1 and 140-2.

In the present invention, indexes stored and managed by partial indexers 140 are referred to as partial indexes. The partial indexers 140 store and manage partial index data in a memory or file.

Meanwhile, the block number indexer 131 generates an index of which a key is a block number. The block number indexer 131 may perform indexing with several divided indexes. Accordingly, the query manager 110 may perform distributed processing and parallel processing using search results for divided indexes (e.g., file indexes) of the block number indexer 131.

An indexing process of the device for searching for blockchain data will be described below with reference to FIG. 3. The indexing process includes operations S210 to S240.

Operation S210 is an operation in which the user application 20 transmits a data storage request to the query manager 110. In other words, the user application 20 transmits original data to be stored in the blockchain network 40 to the query manager 110 along with a data storage request message.

In operation S220, the query manager 110 requests the blockchain network 40 to store the original data, and when storage of the original data is completed, receives a block number and a transaction ID from the blockchain network 40 as result values.

In operation S230, the query manager 110 sets an index ID corresponding to the original data stored in the blockchain network 40, encrypts the original data, and then forwards a request to index the encrypted data, the block number, and the transaction ID with a set index ID to the index manager 120. In this case, the query manager 110 forwards the encrypted data, the block number, and the transaction ID to the index manager 120 together with the index ID.

In operation S240, in response to the request from the query manager 110, the index manager 120 sets indexers 130-1, 130-2, and 130-3 according to the individual index ID and then stores an index (index data) in which the encrypted data is a key value and the block number and the transaction ID are values. In this case, each of the indexers 130-1, 130-2, 130-3, etc. performs indexing using a comparison operation without decrypting the encrypted data. When an index exceeds a certain division criterion (e.g., a block number), the index manager 120 controls the indexers 13-1, 130-2, 130-3, etc. so that the indexers 13-1, 130-2, 130-3, etc. generate and manage an additional file index. The index manager 120 manages latest data as a memory-based index.

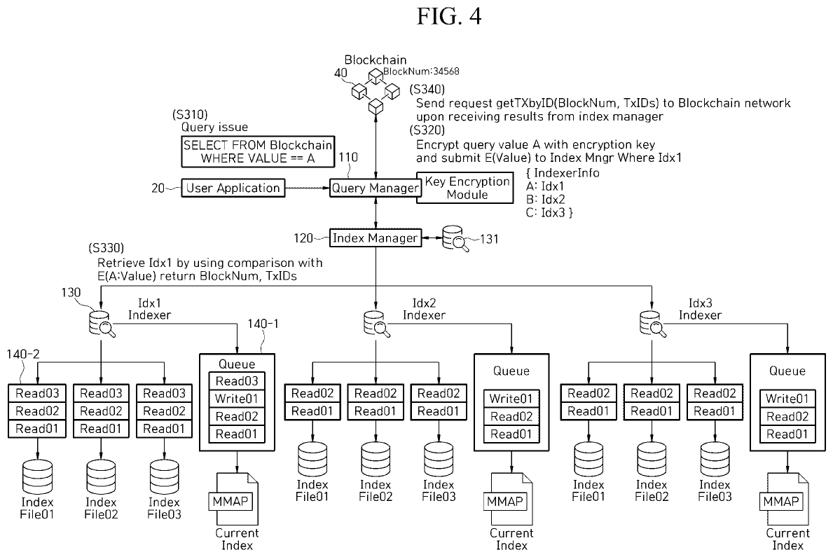

FIG. 4 is a diagram illustrating a data request process of the device for searching for blockchain data according to the exemplary embodiment of the present invention. FIG. 4 shows a process in which, when the user application 20 searches for data in the blockchain network 40 through the device 100 for searching for blockchain data, the device 100 for searching for blockchain data performs an index search through the indexers 130 and request data from the blockchain network 40 using the search result. The data request process includes operations S310 to S340.

In operation S310, the user application 20 transmits a data query reflecting a user's requirement to the query manager 110 and requests the blockchain network 40 to extract and transmit data satisfying the data query.

In operation S320, the query manager 110 determines an index ID (A: idx1) for efficiently processing the data query, encrypts data included in the query (hereinafter “query data”), and forwards the encrypted data to the index manager 120.

In operation S330, the index manager 120 forwards the encrypted query data and the index search request to an indexer 130 corresponding to the index ID. The indexer 130 simultaneously forwards the index search request and the encrypted query data to partial indexers 140-1, 140-2, and the like managed by the indexer 130, and the partial indexers 140-1, 140-2, and the like individually process the request, extract block numbers and transaction IDs satisfying the requirement (encrypted data) from partial indexes, and forward the search results (the block numbers and transaction IDs) to the query manager 110.

In operation S340, the query manager 110 aggregates the received search results (the block numbers and transaction IDs) and transmits the aggregated search results to the blockchain network 40 to request blockchain data (the original data) which corresponds to a result value and is actually stored in the blockchain network 40.

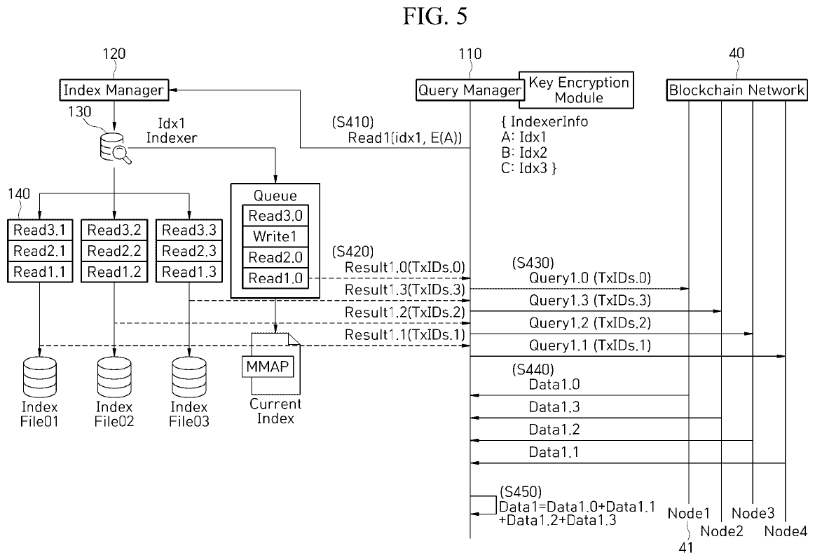

FIG. 5 is a diagram illustrating a blockchain data distribution request and blockchain data aggregation process of the device for searching for blockchain data according to the exemplary embodiment of the present invention. FIG. 5 shows a process in which the query manager 110 requests an index search from the indexers 130 through the index manager 120, receives partial search results, and transmits the search results to the blockchain network 40 to request query target data in parallel. The blockchain data distribution request and blockchain data aggregation process includes operations S410 to S450.

In operation S410, the query manager 110 forwards the index ID of an indexer 130 which manages specific data and a search condition (encrypted query data) to the index manager 120. The index manager 120 forwards the search condition to the indexer 130 corresponding to the index ID.

In operation S420, each indexer 130 forwards the search condition and a search request to one or more partial indexers 140 managed by the indexer 130. The partial indexers 140 individually process the search request. The partial indexers 140 extract block numbers and transaction IDs satisfying the search condition as search results and individually forward the search results to the query manager 110.

In operation S430, the query manager 110 requests distribution of blockchain data (the original data) by transmitting the individual search results (the block numbers and the transaction IDs) to the plurality of nodes 41 included in the blockchain network 40. The present invention assumes that the query manager 110 has or accesses node generation setting file information, that is, information on nodes.

In operation S440, the plurality of nodes 41 in the blockchain network 40 search for transaction data (original data) satisfying the requested transaction IDs (or combinations of a block number and a transaction ID), extract the transaction data, and forward the transaction data to the query manager 110. When a block number and a transaction ID or a transaction ID value is given, the general nodes 41 in the blockchain network 40 may directly find stored blockchain data without searching through blockchain data.

In operation S450, the query manager 110 generates final blockchain data by aggregating blockchain data (original data) received from the plurality of nodes 41 in the blockchain network 40 and forwards the blockchain data to the user application 20.

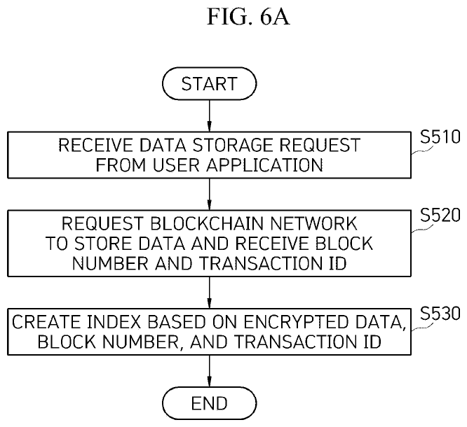

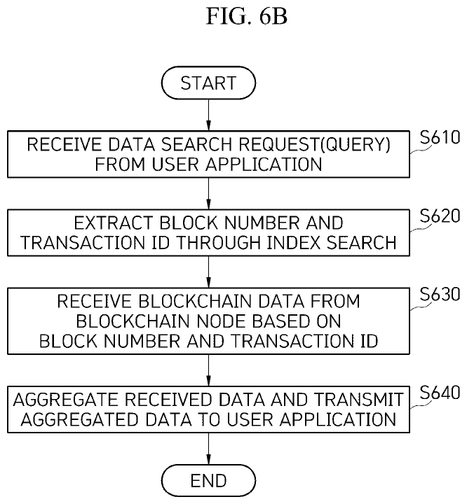

FIGS. 6A and 6B are flowcharts illustrating a method of creating an index for blockchain data and a method of searching for blockchain data according to an exemplary embodiment of the present invention.

FIG. 6A is a flowchart illustrating a method of creating an index for blockchain data according to an exemplary embodiment of the present invention.

The method of creating an index includes operations S510 to S530. The method of creating an index for blockchain data illustrated in FIG. 6A is in accordance with the exemplary embodiment, and operations of the method of creating an index for blockchain data are not limited to the embodiment shown in FIG. 6A and may be added, changed, or removed as necessary.

In operation S510, the device 100 for searching for blockchain data receives a data storage request from the user application 20. The device 100 for searching for blockchain data receives original data from the user application 20 and is requested to store the original data in the blockchain network 40.

In operation S520, the device 100 for searching for blockchain data requests the blockchain network 40 to store the original data, and when storage of the original data is completed, receives a block number of a block in which the original data is stored and a transaction ID from the blockchain network 40.

In operation S530, the device 100 for searching for blockchain data encrypts the original data received from the user application 20 and creates an index on the basis of the encrypted original data, the block number, and the transaction ID.

FIG. 6B is a flowchart illustrating a method of searching for blockchain data using an index according to an exemplary embodiment of the present invention. The search method includes operations S610 to S640. The method of searching for blockchain data using an index illustrated in FIG. 6B is in accordance with the exemplary embodiment, and operations of the method of searching for blockchain data using an index are not limited to the embodiment shown in FIG. 6B and may be added, changed, or removed as necessary.

In operation S610, the device 100 for searching for blockchain data receives a data search request (data query) from the user application 20.

In operation S620, the device 100 for searching for blockchain data encrypts a search condition (query data) included in the query and searches for an index using the encrypted search condition data (encrypted query data) to extract a block number and a transaction ID corresponding to the data.

In operation S630, the device 100 for searching for blockchain data receives blockchain data from the plurality of blockchain nodes 41 on the basis of the extracted block number and transaction ID.

In operation S640, the device 100 for searching for blockchain data generates final blockchain data by aggregating the data received from the plurality of blockchain nodes 41 and transmits the generated final blockchain data to the user application 20.

The method of creating an index for blockchain data and the method of searching for blockchain data using an index have been described above with reference to the flowcharts shown in the drawings. For simplicity, the method has been shown and described as a series of blocks, but the present invention is not limited to the order of the blocks, and some of the blocks may be performed at the same time or in a different order from that shown and described herein. Also, many different branches, flow paths, and sequences of blocks for achieving the same or similar results may be implemented. In addition, not all the shown blocks may be required to implement the method described herein.

In the descriptions of FIGS. 6A and 6B, operations may be subdivided into additional operations or combined into fewer operations according to an implementation example of the present invention. Also, some operations may be omitted as necessary, and the order of operations may change. The description of FIGS. 1 to 5 may apply to FIGS. 6A and 6B even when not explicitly stated. Further, the description of FIGS. 6A and 6B may apply to FIGS. 1 to 5.

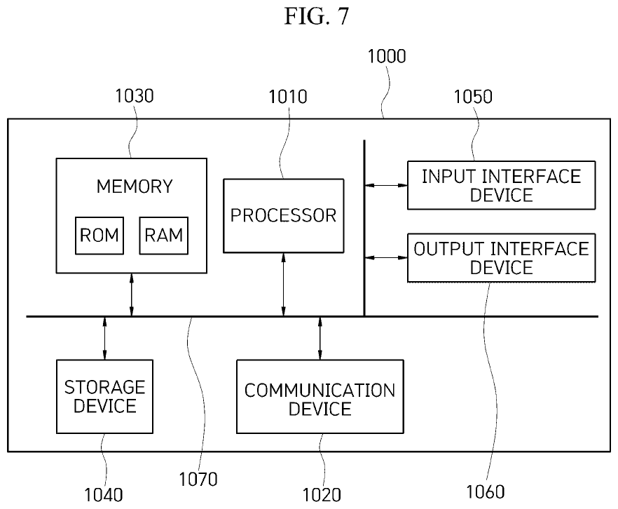

FIG. 7 is a block diagram of a computer system for implementing the method of creating an index for blockchain data and the method of searching for blockchain data. The device 100 for searching for blockchain data according to the exemplary embodiment of the present invention may be implemented in the form of the computer system of FIG. 7.

Referring to FIG. 7, a computer system 1000 may include at least one of at least one processor 1010, a memory 1030, an input interface device 1050, an output interface device 1060, and a storage device 1040 that communicate through a bus 1070. The computer system 1000 may further include a communication device 1020. The processor 1010 may be a central processing unit (CPU) or a semiconductor device for executing computer-readable instructions stored in the memory 1030 or the storage device 1040. The memory 1030 and the storage device 1040 may include various forms of volatile or non-volatile storage media. For example, the memory 1030 may include a read-only memory (ROM) and a random-access memory (RAM). According to embodiments of the present disclosure, the memory 1030 may be present in or out of the processor 1010 and connected to the processor 1010 through various well-known devices. The memory 1030 is one of various forms of volatile or non-volatile storage media. For example, the memory 1030 may include a ROM or RAM.

Therefore, an exemplary embodiment of the present invention may be implemented as a method by a computer or as a non-transitory computer-readable medium in which computer-executable instructions are stored. In an exemplary embodiment, the processor 1010 may, by executing the computer-readable instructions, perform a method according to at least one aspect of the present disclosure.

The communication device 1020 may transmit or receive a wired signal or wireless signal.

Also, a method according to an embodiment of the present invention may be implemented in the form of program instructions that are executable by various computing devices and recorded on a computer-readable medium.

The computer-readable medium may include program instructions, data files, data structures, and the like solely or in combination. The program instructions recorded on the computer-readable medium may be specially designed and prepared for embodiments of the present invention or may be instructions which are well-known and available to those skilled in the field of computer software. The computer-readable medium may include a hardware device configured to store and execute the program instructions. Examples of the computer-readable medium may be magnetic media, such as a hard disk, a floppy disk, and magnetic tape, optical media, such as a compact disc ROM (CD-ROM) and a digital versatile disc (DVD), magneto-optical media, such as a floptical disk, and hardware devices such as a ROM, a RAM, a flash memory, and the like. Examples of the program instructions include machine code generated by a compiler and high-level language code that is executable by a computer using an interpreter or the like.

As described above, the memory 1030 and the storage device 1040 store computer-readable instructions. The processor 1010 is implemented to execute the instructions.

According to an exemplary embodiment of the present invention, by executing the instructions, the processor 1010 receives original data to be stored in the blockchain network 40 from the user application 20, requests the blockchain network 40 to store the original data, receives a block number of a block in which the original data is stored and a transaction ID from the blockchain network 40 when storage of the original data is completed, encrypts the original data, creates an index for the original data including the encrypted original data, the block number, and the transaction ID, and stores the index in the memory 1030.

According to the exemplary embodiment of the present invention, the processor 1010 encrypts the original data by applying a different encryption method according to the type of original data.

For example, when the original data is a string, the processor 1010 applies an encryption algorithm for matching the original data with the encrypted data on a one-to-one basis to encrypt the original data.

For example, when the original data is numeric data, the processor 1010 encrypts the original data by applying an OPE algorithm.

According to the exemplary embodiment of the present invention, when an index stored in the memory 1030 exceeds a range specified by a division criterion, the processor 1010 stores index data corresponding to the range specified by the division criterion in a new file through the storage device 1040. The division criterion may be set on the basis of any one or a combination of a time period, a block number, and a data size.

According to the exemplary embodiment of the present invention, when a query about the original data stored in the blockchain network 40 is received from the user application 20, the processor 1010 encrypts search condition data included in the query and searches for a pre-created index using the encrypted search condition data to extract the block number of the block in which the original data is stored and the transaction ID.

According to the exemplary embodiment of the present invention, the processor 1010 receives blockchain data from a plurality of nodes included in the blockchain network 40 on the basis of the block number and the transaction ID, generates final blockchain data by combining the blockchain data, and transmits the final blockchain data to the user application 20.

According to the exemplary embodiment of the present invention, the processor 1010 creates a plurality of partial indexes including the encrypted search condition data, the block number of the block, and the transaction ID and extracts the block number of the block in which the original data is stored and the transaction ID by simultaneously searching for the plurality of partial indexes using the encrypted search condition data.

Meanwhile, the description of FIGS. 1 to 6B may apply to FIG. 7 even when not explicitly stated. Further, the description of FIG. 7 may apply to FIGS. 1 to 6B.

According to the present invention, encrypted indexes are created for blockchain data, and thus it is possible to prevent external leakage of data.

The present invention employs a “partial indexing method” of dividing blockchain data into certain units, generating indexes for the data units, and managing the blockchain data on the basis of the irreversibility and append-only characteristic of blockchain data. Accordingly, with a method of requesting a blockchain network to do a search in a distributed manner using partial search results received from distributed partial indexes, the present invention can reduce a search time through parallel processing in the blockchain network.

Effects of the present invention are not limited to those described above, and other effects which have not been described above will be clearly understood by those skilled in the technical field to which the present invention pertains from the above description.

Although exemplary embodiments of the present invention have been described above, those skilled in the art will understand that various modifications and alterations can be made without departing from the spirit and scope of the present invention stated in the following claims.

What is claimed is:

1. A method of creating an index for blockchain data, the method comprising operations of:
(a) receiving, by a blockchain data search device, original data to be stored in a blockchain network from a user application;
(b) requesting, by the blockchain data search device, the blockchain network to store the original data and receiving a block number of a block in which the original data is stored and a transaction identifier (ID) from the blockchain network when storage of the original data is completed; and
(c) encrypting, by the blockchain data search device, the original data and creating an index for the original data including the encrypted original data, the block number, and the transaction ID.

2. The method of claim 1, wherein operation (c) comprises applying, by the blockchain data search device, a different encryption method according to a type of original data to encrypt the original data.

3. The method of claim 1, wherein operation (c) comprises, when the original data is a string, applying, by the blockchain data search device, an encryption algorithm for matching the original data with the encrypted data on a one-to-one basis to encrypt the original data.

4. The method of claim 1, wherein operation (c) comprises, when the original data is numeric data, applying, by the blockchain data search device, an order-preserving encryption (OPE) algorithm to encrypt the original data.

5. The method of claim 1, wherein operation (c) comprises, when an index stored in a memory exceeds a range specified by a division criterion, storing, by the blockchain data search device, index data corresponding to the range specified by the division criterion in a new file.

6. The method of claim 5, wherein the division criterion is set on the basis of any one or a combination of a time period, a block number, and a data size.

7. A method of searching for blockchain data using an index, the method comprising operations of:
(a) receiving, by a blockchain data search device, a query about original data stored in a blockchain network from a user application; and
(b) encrypting, by the blockchain data search device, search condition data included in the query and searching for a pre-created index using the encrypted search condition data to extract a block number of a block in which the original data is stored and a transaction identifier (ID).

8. The method of claim 7, further comprising operations of:
(c) receiving, by the blockchain data search device, blockchain data from a plurality of nodes included in the blockchain network on the basis of the block number and the transaction ID; and
(d) combining, by the blockchain data search device, the received blockchain data to generate final blockchain data and transmitting the final blockchain data to the user application.

9. The method of claim 7, wherein operation (b) comprises searching for a plurality of pre-created partial indexes using the encrypted search condition data to extract the block number of the block in which the original data is stored and the transaction ID.

10. A device for searching for blockchain data, the device comprising:
a memory configured to store computer-readable instructions; and
at least one processor configured to execute the instructions,
wherein the at least one processor executes the instructions to receive original data to be stored in a blockchain network from a user application, request the blockchain network to store the original data, receive a block number of a block in which the original data is stored and a transaction identifier (ID) from the blockchain network when storage of the original data is completed, encrypt the original data, create an index for the original data including the encrypted original data, the block number, and the transaction ID, and store the index in the memory.

11. The device of claim 10, wherein the at least one processor encrypts the original data by applying a different encryption method according to a type of original data.

12. The device of claim 10, wherein, when the original data is a string, the at least one processor applies an encryption algorithm for matching the original data with the encrypted data on a one-to-one basis to encrypt the original data.

13. The device of claim 10, wherein, when the original data is numeric data, the at least one processor encrypts the original data by applying an order-preserving encryption (OPE) algorithm.

14. The device of claim 10, further comprising a storage device,
wherein, when an index stored in the memory exceeds a range specified by a division criterion, the at least one processor stores index data corresponding to the range specified by the division criterion in a new file through the storage device.

15. The device of claim 10, wherein, when a query about the original data stored in the blockchain network is received from the user application, the at least one processor encrypts search condition data included in the query and searches for a pre-created index using the encrypted search condition data to extract the block number of the block in which the original data is stored and the transaction ID.

16. The device of claim 15, wherein the at least one processor receives blockchain data from a plurality of nodes included in the blockchain network on the basis of the block number and the transaction ID, generates final blockchain data by combining the blockchain data, and transmits the final blockchain data to the user application.

17. The device of claim 15, wherein the at least one processor creates a plurality of pre-created partial indexes including the encrypted search condition data, the block number, and the transaction ID and extracts the block number of the block in which the original data is stored and the transaction ID by simultaneously searching for the plurality of partial indexes using the encrypted search condition data.
